(19) United States
(12) Patent Application Publication
(10) Pub. No.: US 2009/0180219 A1
(43) Pub. Date: Jul. 16, 2009

(54) APPARATUS FOR DETECTING ERROR OCCURRING TO POWER CONVERTER AND DETECTING METHOD THEREOF

(76) Inventors: Yi-Lun Shen, Hsin-Chu (TW); Da-Chun Wei, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/350,191

(22) Filed: Jan. 7, 2009

(30) Foreign Application Priority Data
Jan. 10, 2008 (TW) 097101005

(51) Int. Cl. H02H 9/00

(52) U.S. Cl. 361/18

(57) ABSTRACT

An apparatus is applicable to a power converter comprising a primary winding for receiving an input voltage and a secondary winding for generating an output voltage to power a load. The apparatus comprises a detecting circuit, a comparing circuit, and a determining circuit. The detecting circuit is configured to generate a feedback signal according to the output voltage. The comparing circuit is coupled to the detecting circuit and configured to compare the feedback signal and a threshold and accordingly generates an indication signal indicative of the over high output voltage. The determining circuit, which is in response to the indication signal, is configured to trigger an over voltage protection mechanism preventing the power converter from powering the load. Since the feedback signal is instantly responsive to the output voltage, the occurrence of an error can be rapidly and correctly detected, allowing rapid and correct protection for the power converter.

### BACKGROUND OF THE INVENTION

1. Field of the Invention

The invention relates to an apparatus and method thereof for detecting an error that occurs to a power converter, and more particularly, to an apparatus and method thereof for detecting if a current sensing resistor of a power converter is grounded.

2. Description of the Prior Art

FIG. 1 is a diagram of a conventional fly-back power converter 100. Fly-back power converter 100 transforms AC input voltage VAC into DC output voltage V_{OUT} through switching transistor Q1. More specifically, energy of rectified input DC signal V_{I} is stored in primary winding Lp of transformer T while transistor Q1 is on, and then the stored energy is delivered to secondary winding Ls of transformer T to form output voltage V_{OUT} while transistor Q1 is off.

The gate of transistor Q1 is coupled to pulse width modulation (PWM) control chip 110 for receiving a PWM signal generated from PWM control chip 110. In this way, transistor Q1 will be alternately turned on and off due to the PWM signal. PWM control chip 110 makes the fly-back transformer 100 generate the expected output voltage V_{OUT} by adjusting the duty cycle of the PWM signal according to the voltage level of the current output voltage V_{OUT} and the primary winding current Ip detected by current sensing pin CS.

However, in a case where current sensing resistor R_{CS} coupled to current sensing pin CS is grounded due to mechanical failure or improper operation, resulting in the source of transistor Q1 being directly shorted to ground, current sensing pin CS cannot detect the over-current status of primary winding current Ip. Hence, PWM control chip 110 may continuously send the PWM signal with a maximum duty cycle to alternately switch transistor Q1 between on and off states, raising output voltage V_{OUT} and even affects operation of circuit(s) coupled to an output port of fly-back power transformer 100.

One conventional solution to this problem is to determine if voltage V_{CC} supplied by an auxiliary winding Laux of the transformer T exceeds an over voltage protection threshold. Because part of the energy in primary winding Lp is also delivered to auxiliary winding Laux while delivering the energy to secondary winding Ls, auxiliary winding Laux charges voltage V_{CC} at the same time when secondary winding Ls charges output voltage V_{OUT}. Hence, when detecting that voltage V_{CC} is higher than the over voltage protection threshold, PWM control chip 110 expects that too much energy is being transferred to both secondary winding Ls and auxiliary winding Laux, and that result could be due to the failure of the current sensing resistor R_{CS}. Accordingly, an over voltage protection to voltage V_{CC} may be enabled to decrease duty cycle of the PWM signal or turn off transistor Q1, lowering the energy transferred in the following switching cycles.

A disadvantage of this solution, however, is that over voltage protection threshold of V_{CC} is set much higher than a normal operational voltage. Thus, for designers, it is very complicated or hard to determine the turn ratio of primary winding Lp to auxiliary winding Laux for differentiating the condition for the over voltage protection from that for the normal operation, taking consideration to both the situations that current sensing pin CS properly functions and that current sensing pin CS is grounded. Besides, during startup, the voltage level of the voltage V_{CC} must be high enough to enable PWM control chip 110 when output voltage V_{OUT} is still around zero. Hence, when the primary winding starts transferring energy stored therein, the diode DSN on the secondary side is turned on quicker than the diode DA on the auxiliary side, causing the secondary winding to gain energy stored in the primary winding before the auxiliary winding does. As a result, the output voltage V_{OUT} rises earlier than the voltage V_{CC}. It is possible that, when the voltage V_{CC} exceeds the preset over voltage protection threshold to enable the over voltage protection, output voltage V_{OUT}, which rises earlier, has already gone over high and adversely influences the circuit(s) coupled.

### SUMMARY OF THE INVENTION

According to one embodiment of the invention, an apparatus applicable to a power converter is provided, wherein the power converter comprises a primary winding for receiving an input voltage and a secondary winding for generating an output voltage to power a load. The apparatus comprises: a detecting circuit, a comparing circuit, and a determining circuit. The detecting circuit is configured to generate a feedback signal according to the output voltage. The comparing circuit is coupled to the detecting circuit and configured to compare the feedback signal and a threshold. Accordingly, the comparing circuit generates an indication signal indicative of a fault condition that the output voltage is over high. The determining circuit, in response to the indication signal, is configured to trigger an over voltage protection mechanism for preventing the power converter from powering the load.

These and other objectives of the present invention will no doubt become obvious to those of ordinary skill in the art after reading the following detailed description of the preferred embodiment that is illustrated in the various Figures and drawings.

### BRIEF DESCRIPTION OF THE DRAWINGS

FIG. 1 is a diagram of a conventional fly-back power converter.

FIG. 2 is a block diagram illustrating one embodiment of a detecting apparatus according to the present invention.

FIG. 3 is a diagram illustrating an exemplary embodiment of an internal circuit of the detecting apparatus in FIG. 2 that is applied to a fly-back power converter.

FIG. 4 is a diagram illustrating waveforms of a feedback signal, an indication signal, an output signal of a flip flop, an error detecting signal, and a power-good signal.

### DETAILED DESCRIPTION

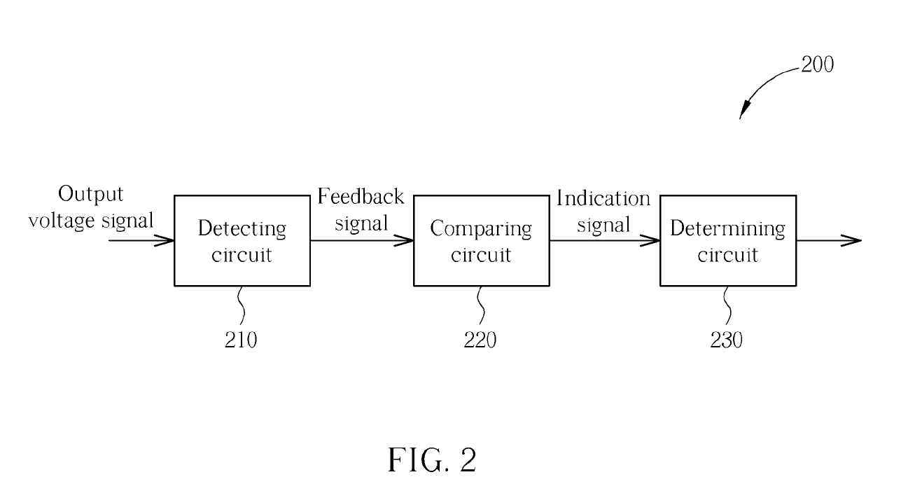

The detecting apparatus 200 in FIG. 2 uses a feedback signal representing the output voltage of the power converter to serve as a detecting target. The detecting apparatus 200 determines if the output voltage is over high and therefore a corresponding over voltage protection would be enabled by comparing the feedback signal with a threshold.

The detecting apparatus 200 includes a detecting circuit 210, a comparing circuit 220 and a determining circuit 230. Detecting circuit 210 generates a feedback signal according to output voltage Vout of a power converter (not shown in FIG. 2). Comparing circuit 220 compares the feedback signal with a threshold and accordingly generates an indication signal indicative of a fault condition that output voltage Vout is over high. Determining circuit 230, in response to the indication signal, determines whether to trigger an over voltage protection mechanism that prevents the power converter from powering the load that the power converter originally powers. For example, when detecting that output voltage Vout is over high, detecting apparatus 200 controls a PWM control chip of the power converter to adjust the time period of turning on the power transistor coupled to the primary winding of the power converter or to constantly turn off the power transistor, thereby lowering the voltage level of the output voltage to a safe range. By this way, the over-high output voltage Vcc, whose root cause is believed to be a failed current sensing resistor that has almost zero-ohm resistance, could be avoided.

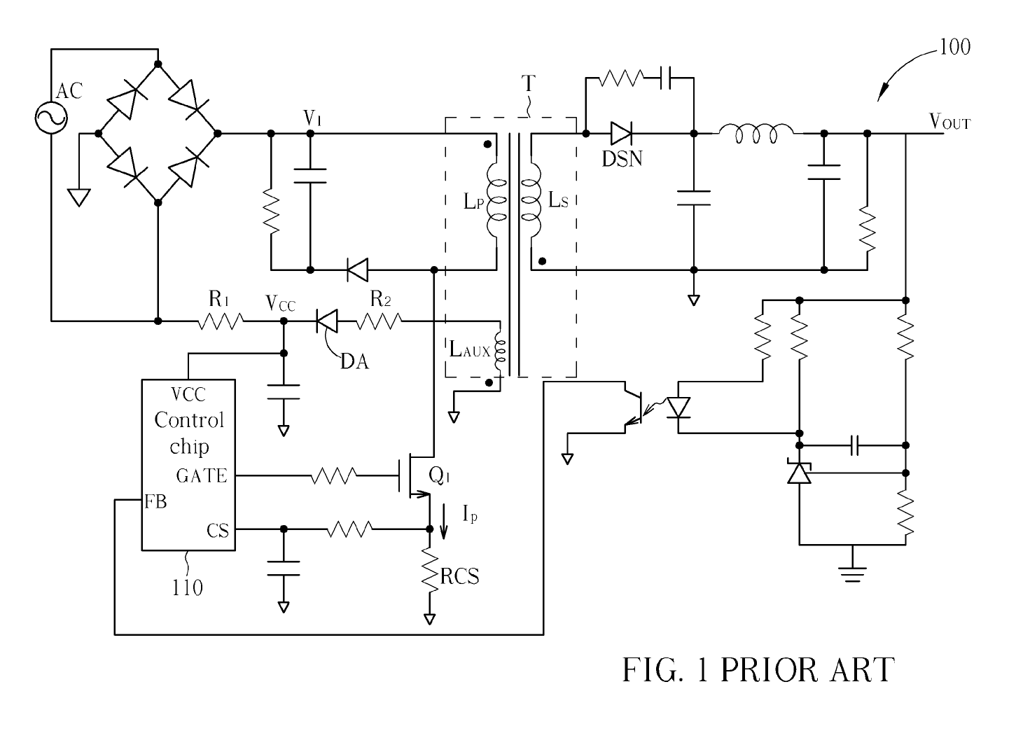

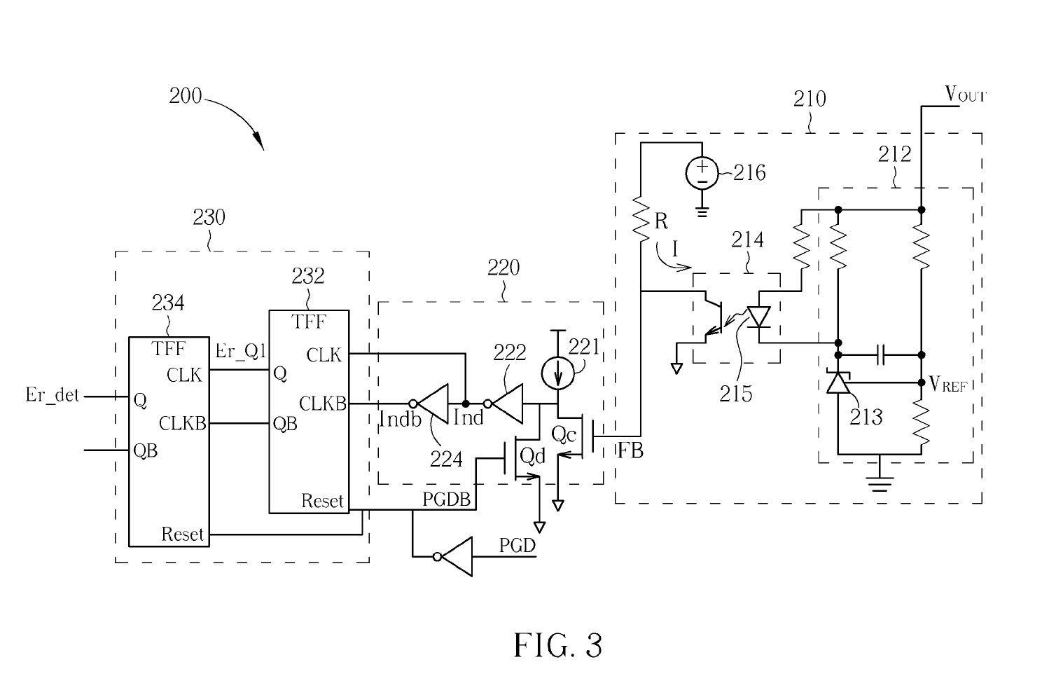

FIG. 3 is a diagram illustrating an exemplary embodiment of an internal circuitry of the detecting apparatus 200 applicable to the fly-back power converter shown in FIG. 1. Detecting circuit 210 includes a regulator 212 with three-terminal shunt regulator 213, and a photo coupler 214 with light emitting diode (LED) 215, corresponding elements of which can be found in FIG. 1. While the output voltage V_{OUT} of the power converter is greater than a reference voltage V_{REF}, the sink current of the regulator 213 increases accordingly, making the light emitting diode (LED) 215 of the photo coupler 214 become brighter and generating a current I corresponding to the output voltage V_{OUT} at the output end of the photo coupler 214 due to photo-electric conversion. As the output end of the photo coupler 214 is further coupled to an impedance component (e.g., a resistor R) and a voltage source 216, the feedback signal FB generated by the detecting circuit 210 is inversely proportional to the output voltage V_{OUT}, which means that the higher the output voltage V_{OUT}, the smaller the voltage of the feedback signal FB. Therefore, the voltage level of the feedback signal FB could drop to a value close to a ground potential when output voltage V_{OUT} is higher than an over voltage protection threshold. Please note that, compared to the detection to the voltage V_{CC} of the conventional auxiliary winding, this embodiment of the present invention can react rapidly and correctly in response to the magnitude of the output voltage V_{OUT} because the feedback signal FB and the output voltage V_{OUT} are instantly responsive to each other.

Feedback signal FB generated by detecting circuit 210 is fed into comparing circuit 220, which—as mentioned above—generates an indication signal Ind by comparing the voltage level of the feedback signal FB with a threshold. In this exemplary embodiment, comparing circuit 220 includes transistor Qc, transistor Qd, a current source 221, inverter 222 and inverter 224, where the aforementioned threshold is the threshold voltage Vth of transistor Qc. Transistor Qc has a control end (gate) receiving the feedback signal FB, and two ends respectively coupled to current source 221 and ground. Transistor Qd has a control end (gate) controlled by the inverse signal of a power good signal, and two ends respectively coupled to current source 221 and ground. Turning on of any one of transistors Qc and Qd lowers the voltage at the input terminal of inverter 222, causing indication signal Ind at a high voltage level and indication signal Indb at a low voltage level. In the opposite, it requires transistors Qc and Qd both turned off to have indication signal Ind at a low voltage level and indication signal Indb at a high voltage level.

Accordingly, when power is good ( i.e. power good signal PGD is at high voltage level), transistor Qd is turned off and signal Ind at a high/low voltage level will indicate that feedback signal FB has a voltage level higher/lower than the threshold voltage Vth of the first transistor Qc.

When output voltage V_{OUT} of the power converter remains in a normal working range and power is good, the voltage level of the feedback signal FB is not lower than the threshold voltage Vth of transistor Qc, and thus transistor Qc remains on. However, if any error occurs to the power converter to raise the output voltage V_{OUT} over a voltage limit and pull down the voltage level of feedback signal FB below the threshold voltage Vth of transistor Qc, transistor Qc is turned off, changing the logic state of indication signals Ind and Indb. Therefore, in this exemplary embodiment, the level transition of indication signal Ind from the high voltage level to the low voltage level could represent that the voltage level of the feedback signal FB is lower than the threshold voltage Vth.

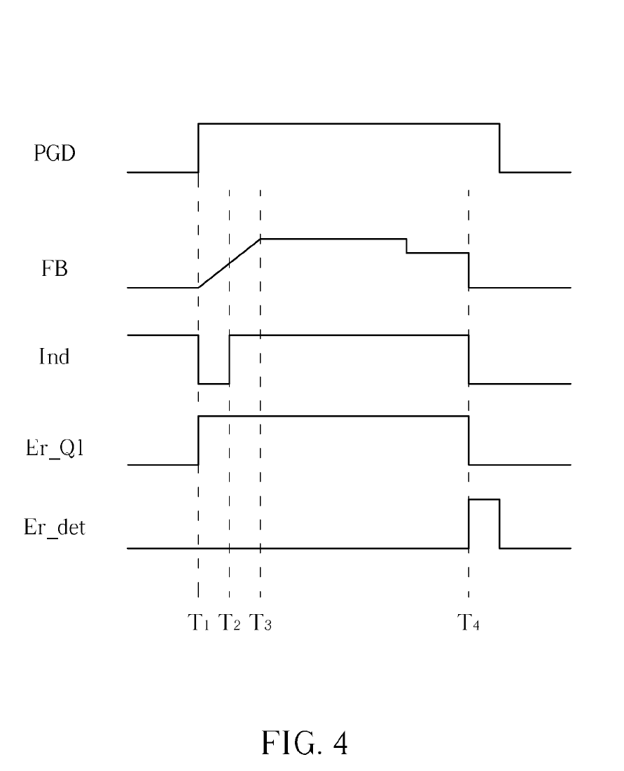

Indication signal Ind and its inverse signal Indb (i.e., the output of the second inverter 224) are both transmitted to determining circuit 230 for error occurrence detection. In general, determining circuit 230 determines that the voltage level of output voltage Vout is over high and triggers an over voltage protection mechanism immediately when a level transition of indication signal Ind from a high voltage level to a low voltage level is detected. However, it should be noted that, in this exemplary embodiment, indication signal Ind also has another level transition from a high voltage level to a low voltage level when the power converter is just powered on. Please refer to FIG. 4 in conjunction with FIG. 3. FIG. 4 is a diagram illustrating waveforms of the power-good signal PGD, the feedback signal FB, the indication signal Ind, an output signal Er_Q1 of a flip flop 232, and an error detecting signal Er_det which is an output signal of the determining circuit 230.

As can be seen by referring to FIG. 3 and FIG. 4, before time T₁ the system power is not supplied normally, the power-good signal PGD indicates the power is no good and forces the voltage level of the feedback signal FB to be low, such that transistor Qc is turned off, transistor Qd is turned on, and the voltage level at the drain of transistor Qd is pulled down to a low voltage level. As a result, the voltage level of the indication signal Ind is at a high voltage level. After the power-good signal PGD undergoes a transition from a logic low voltage level to a logic high voltage level, transistor Qc and transistor Qd are both turned off, and current source 221 pulls the voltage level at the drain of transistor Qd up to a high voltage level. As a result, the indication signal Ind lowers. This level transition of the indication signal Ind triggers flip flop 232 to make the output signal Er_Q1 of flip flop 232 have a rising edge. At the same time, soon after the voltage level of the power-good signal PGD is pulled up, the voltage level of the feedback signal FB begins establishing and then rises over the threshold voltage Vth of transistor Qc at time T₂. This turns on transistor Qc, pulls the voltage level at the drain of transistor Qc (i.e., the input voltage of the inverter 222) down to a low voltage level, and makes the indication signal Ind having a rising edge. In order to avoid making an erroneous judgment on the error occurrence at time T₁, determining circuit 230 uses two T-type flip flops 232 and 234 cascaded in series to cope with the indication signal Ind.

At time T₁, the indication signal Ind and the inverse indication signal Indb trigger flip flop 232, while the error detecting signal Er_det at the output end of the comparing circuit 220 still remains at a zero potential. When the output voltage V_{OUT} of the power converter gradually rises up to a normal voltage level (in an interval between T₃ and T₄), the voltage level of the feedback signal FB may be slightly decreased, but is not lower than the threshold voltage Vth of transistor Qc. Therefore, the indication signal Ind and the error detecting signal Er_det remain in their respective original states. An error is supposed to occur at time T₄ to indicate that the voltage level of the output voltage V_{OUT} is boosted abnormally. At time T₄, the voltage level of the feedback signal FB is decreased to a value close to a zero potential, which makes transistor Qc and transistor Qd both turned off. At this moment, indication signal Ind is induced to have a falling edge and flip flop 232 is triggered once more. Then, output signal Er_Q1 of flip flop 232 undergoes a level transition from high to low, which triggers flip flop 234 to make the output signal Er_det of the flip flop 234 having a rising edge, as shown in FIG. 4. That is, the determining circuit 230 determines that the current sensing resistor R_{CS} may be grounded only when the indication signal Ind undergoes a level transition from a high voltage level to a low voltage level twice. In other words, the situation where the current sensing resistor R_{CS} is grounded may be confirmed when the voltage level of the feedback signal FB is lower than the threshold voltage Vth of transistor Qc under the condition that the voltage level of the feedback signal FB has reached a steady state after the power converter is turned on.

The error detecting signal Er_det can inform the control chip to adjust the energy transfer of the transformer in the power converter to thereby decrease the output voltage V_{OUT} into a safe working range, or signal a user of the power converter to instruct them to eliminate the error. Then the power-good signal PGD may be enabled again, and flip flops 232 and 234 may be reset. However, the use of the error detecting signal Er_det is not limited to indicate a failed current sensing resistor R_{CS}, but could be for indicating other failure situations. The aforementioned implementation is for illustrative purposes only.

One skilled in the art will readily appreciate that the circuitry shown in FIG. 3 merely serves as one exemplary embodiment of the invention. Other circuit configurations which obey the spirit of the present invention can also achieve the characteristics and advantages of the invention. One skilled in the art can easily appreciate how to realize these alternative designs after reading the above paragraphs. Further description is omitted here for the sake of brevity.

In addition, the detecting apparatus 200 can be placed in a position external to the control chip, be integrated with the control chip, or be partially disposed outside of the control chip and partially integrated with the control chip. For instance, in one implementation, regulator 212 and photo coupler 214 are placed outside of the control chip and coupled to the output voltage V_{OUT}, and power source 216, impedance component R, comparing circuit 220 and determining circuit 230 are integrated with the control chip.

Briefly summarized, detecting apparatus 200 can rapidly and correctly detect occurrence of errors by detecting a feedback signal which has a certain relationship with the output voltage V_{OUT} of the power converter. In addition, the structure of detecting apparatus 200 is simple and does not require extra pins to be added to the power converter, which can greatly save both area and production costs. As the voltage range associated with the enablement of the over voltage protection (i.e., the range of the voltage level of the feedback signal FB lower than the threshold voltage Vth of the first transistor Qc) is lower than the voltage level under a burst mode (usually 1.4V), the normal operation of the power converter is not affected. Please note that the detecting apparatus 200 is not limited to detecting errors caused by the current sensing resistor which is unwittingly grounded. Instead, any errors leading to an abnormal output voltage V_{OUT} can be detected using the detecting apparatus 200 of the present invention.

Those skilled in the art will readily observe that numerous modifications and alterations of the device and method may be made while retaining the teachings of the invention.

What is claimed is:

1. An apparatus applicable to a power converter comprising a primary winding for receiving an input voltage and a secondary winding for generating an output voltage to power a load, the apparatus comprising:
a detecting circuit, configured to generate a feedback signal according to the output voltage;
a comparing circuit, coupled to the detecting circuit and configured to compare the feedback signal and a threshold and accordingly generate an indication signal indicative of a fault condition that the output voltage is over high; and
a determining circuit, in response to the indication signal, configured to trigger an over voltage protection mechanism preventing the power converter from powering the load.

2. The apparatus of claim 1, wherein the indication signal indicates that the output voltage is over high when a voltage level of the feedback signal is lower than the threshold.

3. The apparatus of claim 1, wherein the comparing circuit comprises:
a first transistor, including a control end for receiving the feedback signal, wherein the threshold corresponds to a threshold voltage level of the first transistor.

4. The apparatus of claim 3, wherein the comparing circuit further comprises:
a second transistor, including a control end controlled by a power good signal, and two ends coupled to the first transistor.

5. The apparatus of claim 1, wherein the determining circuit comprises a plurality of T-type flip flops cascaded in a series.

6. A method for a power converter comprising a primary winding for receiving an input voltage and a secondary winding for generating an output voltage, the method comprising:
generating a feedback signal according to the output voltage;
generating an indication signal indicative of a voltage-level comparing result between the feedback signal and a threshold; and
determining if the output voltage is over high according to the indication signal.

7. The method of claim 6, wherein the output voltage is determined to be over high when a voltage level of the feedback signal that has reached a steady state after the power converter is turned on is lower than the threshold.
